(19) United States
(12) Patent Application Publication
(10) Pub. No.: US 2026/0106195 A1
(43) Pub. Date: Apr. 16, 2026

(54) REGENERATION METHODS AND FUEL CELL SYSTEM

(71) Applicant: Robert Bosch GmbH, Stuttgart (DE)

(72) Inventors: Matthias Martin Hanauer, Leonberg (DE); Thilo Lehre, Stuttgart (DE); Thomas Mittermeier, München (DE); Ulrich Berner, Stuttgart (DE)

(21) Appl. No.: 19/116,453

(22) PCT Filed: Sep. 18, 2023
(86) PCT No.: PCT/EP2023/075567

§ 371 Date: Mar. 28, 2025

(30) Foreign Application Priority Data
Sep. 29, 2022 (DE) 10 2022 210 306.8

(51) Int. Cl. H01M 8/06; H01M 8/04746; H01M 8/04858

(52) U.S. Cl. CPC H01M 8/06; H01M 8/04746; H01M 8/04873

(57) ABSTRACT

The invention presented relates to a regeneration method (100) for regenerating a contaminated fuel cell stack (201). The regeneration method (100) comprises:
introducing (101) reconditioning reagent into the fuel cell stack (201),
flushing (103) the reconditioning reagent from the fuel cell stack (201), wherein the reconditioning reagent contains mobile anions or a precursor of mobile anions.

### BACKGROUND

The present invention relates to a regeneration method and a fuel cell system.

Fuel cells are electrochemical energy converters used, for example, to convert hydrogen (H₂) and oxygen (O₂) into water (H₂O), electrical energy and heat.

The porous electrodes of a PEM fuel cell, most commonly called a catalyst layer, typically consist of nano-metal particles (catalyst) made of platinum or platinum alloys supported on larger carbon particles. These carbon particles provide electron and heat transport, high dispersion of the active platinum or alloy metal, as well as sufficient material transport due to their porosity.

In addition, a catalyst layer is permeated with an ionomer, to ensure its proton conductivity.

Three phase boundaries are required for an electrochemical reaction, and result from the concurrence of platinum, ionomer and reactant.

Impurities, in particular metal ions, may accumulate in the membrane as well as the electrodes of a fuel cell over the course of the fuel cell's lifetime for various reasons. These reasons may include, for example, corrosion of the metallic bipolar plate (e.g., Fe^{2+/3+} ions), and transporting these ions into the MEA in aqueous phase, degradation reactions of the catalyst in the catalyst layers, depending on the alloy used, additives that are used, for example, as radical scavengers or other impurities or contaminants, such as from the manufacturing process or from an operation of a fuel cell system.

The accumulation of positively charged ions (cations) is associated with a reduction of the proton concentration in ionomer-containing phases which involve cation exchange materials having a predetermined quantity of immobilized negatively charged counterions (anions).

Particularly at higher loads (current densities) fuel cells therefore experience a reduction of ionic conductivity and thus a loss of efficiency (lower voltage at given current density), since the metal cations migrate to the cathodic electrode and reduce the proton conduction therein without themselves contributing to the electrochemical reaction.

An exception are noble metal ions, in particular platinum ions, which are electrochemically reduced back to metallic Pt at high loads and thus replaced again by protons. The accumulation of less chemically noble metal ions in the course of degradation effects, such as CO²⁺, Ni²⁺ and/or Fe^{2+/3+}.

It is assumed that the accumulated cations remain largely in the ion-conducting phases of the MEA as they are held there due to the counter-loading of the anionic groups of the ionomers.

Known countermeasures are usually limited to preventing or slowing the accumulation of metal cations in the MEA, for example through the selected catalyst material, by preventing/slowing the degradation reactions, or by preventing the transport of contaminants from the flow field into the MEA.

### SUMMARY

Presented in the context of the invention presented are a regeneration method and a fuel cell system. Further features and details of the invention arise from the respective dependent claims, the description, and the drawings. In this context, features and details described in connection with the regeneration method according to the invention clearly also apply in connection with the fuel cell system according to the invention, and respectively vice versa, so that mutual reference to the individual considerations of the invention always is or can be made with respect to the disclosure.

The present invention serves in particular to provide a robust fuel cell system.

Therefore, according to a first aspect of the invention presented, a regeneration method for regenerating a contaminated fuel cell system is presented. The regeneration method comprises introducing reconditioning reagent into the fuel cell stack and flushing the reconditioning reagent out of the fuel cell stack, wherein the reconditioning reagent contains mobile anions or a precursor or preliminary stage of mobile anions, respectively.

Mobile anions, in the context of the invention presented, are to be understood to mean in particular free anions that are dissolved, for example, in a solution. In the context of the invention presented, a precursor or preliminary stage of mobile anions is to be understood to mean in particular chemical compounds from which mobile anions can be formed in the fuel cell stack.

The invention presented is based on the principle that mobile anions are introduced in ionomer-containing phases of a MEA or fuel cell, without simultaneously introducing further cations that are not protons. These mobile anions are capable of being discharged together with mobile cations in the form of salt pairs or agglomerates from the ionomer-containing phases of the MEA as such units are electrically neutral and thus no longer held by the ionomer containing immobilized anions.

The rinsing is carried out by the water produced by the fuel cell reaction if suitable operating conditions are selected, as well as a fluid flowing through a flow field of a respective fuel cell, such as gas and/or liquid water. Impurities in the form of interfering metal cations are flushed out of the fuel cell together with the anions introduced by the reconditioning reagent in the form of salt pairs, complexes or agglomerates. The excess anions leave the fuel cell in protonated form.

In particular, the substances forming the reconditioning reagent are selected and if necessary combined/mixed so that the affinity of the anions to the cations to be removed is neither too low nor too high in order to facilitate both the most efficient possible discharge of the cations compared to the anion leaving in its protonated form, as well as to avoid local precipitation as a poorly soluble salt which, while preventing discharge, can in further operation re-release the interfering ions. This is the case unless the poor solubility is sufficient to cause a permanent binding of the interfering cation. In particular, the composition of the reconditioning reagent is optimized so that cations that have a helpful effect, e.g., the Ce³⁺ used as a radical scavenger is not flushed or is only temporarily precipitated.

In particular, the reconditioning reagent is introduced into a cathode subsystem, optionally a cathode subsystem and an anode subsystem of the fuel cell stack.

It may be contemplated that the reconditioning reagent is gaseous and comprises an electrically neutral base gas, in particular carbon dioxide and/or dinitrogen tetroxide, that dissociates upon dissolution in water into protons and anions.

Carbon dioxide is particularly well suited for use as a reconditioning reagent due to its low combustibility and low cost.

It may further be provided that the base gas is converted or can be converted electrochemically to an anionic species in the dissolved state and upon application of a voltage.

A gas capable of being converted by an electric voltage to an anionic species, such as dinitrogen tetroxide, may be activated by an electric voltage provided in the fuel cell stack, i.e., converted into its anionic species to react where it is intended to react, namely in the fuel cell stack.

In the case of a liquid reconditioning reagent, this is pulsed or introduced as spray, for example, in order to ensure a regular supply of oxygen.

It may further be contemplated that the reconditioning reagent comprises at least one acid in an aqueous phase.

An acid, such as sulfuric acid, nitric acid, hydrochloric acid, phosphoric acid, citric acid, oxalic acid or ethylenediaminetetraacetic acid maximizes discharge of cations from the fuel cell stack as it binds the cations and can be flushed out of the fuel cell stack together with the cations.

Further, an acid causes reaction conditions to be adjusted advantageously for a reaction between cations and the reconditioning reagent, for instance by causing a low pH.

It may further be contemplated that the reconditioning reagent comprises at least one chelating agent in the aqueous phase.

A chelating agent maximizes cation discharge from the fuel cell stack as it binds the cations and can be flushed out of the fuel cell stack together with the cations.

It may further be provided that at least one acid and/or at least one chelating agent may be present as dissolved ions or in molecular form.

Depending on the reconditioning reagent, which may comprise, for example, a carrier in the form of a gas or a liquid, additives, such as an acid and/or a chelating agent, may be dissolved therein or may be contained therein in molecular form.

It may further be provided that the reconditioning reagent comprises a solution comprising a substance, in particular ammonium carbonate, that can be converted to a neutral or anionic substance by applying an electrical voltage.

A conditioning reaction for regeneration of the fuel cell stack can be controlled via a voltage applied in the fuel cell stack through a substance that is converted or can be converted to a neutral or anionic substance by applying an electrical voltage.

It may further be provided that the reconditioning reagent and impurities may be flushed out by water produced in the fuel cell stack.

For example, to flush out the reconditioning reagent, the fuel cell stack can be switched to an operating state in which a particularly high volume of liquid water is produced.

It may further be provided that, when flushed under wet-cold operating conditions, a cell voltage is set that is below a predetermined regeneration value.

Lowering a cell voltage below a predetermined regeneration value causes the reduction of other contaminants adsorbed at the catalyst surface, such as sulfate or sulfonate, such that multiple, e.g., independent regeneration processes are carried out at the same time within the same regeneration method.

For example, the regeneration method is implemented as part of a reconditioning protocol that also eliminates other reversible aging effects. This is particularly advantageous in combination with a procedure for reducing and flushing contaminants on the catalyst surface. In this procedure, under a cold-wet operating condition of, for example, 40° C. at 100% relative humidity, a low cell voltage is set so that a large amount of liquid water is produced in the catalyst layer. In this state, the reconditioning reagent is introduced to the cathode side via the media supply of the fuel cell stack mixed with air or oxygen.

Optionally, an alternative or additional introduction on the anode side is also possible. After application of the reconditioning reagent, the cold-wet operating condition continues to be maintained for a predetermined time to flush out the reconditioning reagent and the contaminants.

It may further be provided that, upon or after introduction of the reconditioning reagent, a voltage applied to the fuel cell stack is increased above a predetermined conditioning value to initiate a reaction of the reconditioning reagent with impurities present in the fuel cell stack.

According to a second aspect, the presented invention relates to a fuel cell system for converting energy. The fuel cell system comprises a fuel cell stack, a dosing system for metering reconditioning reagent into the fuel cell stack, and a computing unit, wherein the computing unit is configured to activate the dosing system and the fuel cell stack to perform a possible configuration of the reconditioning method presented.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description can each be essential to the invention individually or in any combination.

Shown are:

FIG. 1 a representation of a potential embodiment of the presented regeneration method,

FIG. 2 a schematic representation of one possible embodiment of the presented fuel cell system.

### DETAILED DESCRIPTION

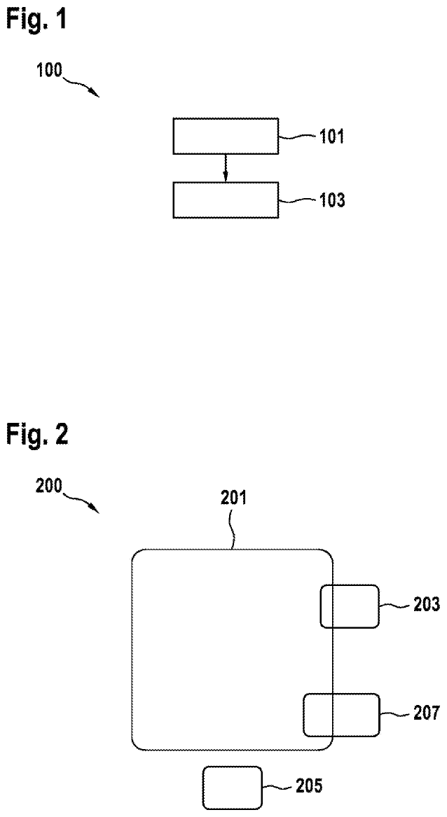

FIG. 1 shows a regeneration method 100 for regenerating a fuel cell stack. The regeneration method 100 comprises an introduction step 101 in which a reconditioning reagent is introduced into the fuel cell stack, i.e., sprayed, for example.

Further, the regeneration method 100 comprises a flushing step 103 in which the reconditioning reagent is flushed out of the fuel cell stack along with any impurities dissolved in the reconditioning reagent.

It is provided according to the present invention that the reconditioning reagent contains mobile anions or a precursor of mobile anions so that the reconditioning reagent binds impurities in the form of cations, in particular metallic cations.

FIG. 2 shows a fuel cell system 200. The fuel cell system 200 comprises a fuel cell stack 201, a dosing system 203 for metering reconditioning reagent into the fuel cell stack 201, and a computing unit 205.

For example, the dosing system 203 may comprise a tank, particularly a pressure tank, a valve, and a pump.

The computing unit 205 may be, for example, a computer, a controller, a processor, or any other programmable circuit.

The computing unit 205 is configured to control the dosing system 203 and the fuel cell stack 201 to perform the reconditioning method 100 according to FIG. 1.

Optionally, the dosing unit 203 and/or the computing unit 205 can be connected to the fuel cell system 200 via an interface 207, such that the dosing unit 203 and/or the computing unit 205 can be connected to the fuel cell system 200, e.g., in a workshop, to perform the reconditioning method 100 according to FIG. 1.

1. A regeneration method (100) for regeneration of a contaminated fuel cell stack (201),
wherein the regeneration method (100) comprises:
introducing (101) reconditioning reagent into the fuel cell stack (201),
flushing (103) the reconditioning reagent from the fuel cell stack (201), wherein the reconditioning reagent contains mobile anions or a precursor of mobile anions.

2. The regeneration method (100) according to claim 1,
wherein
the reconditioning reagent is gaseous and comprises an electrically neutral base gas, which dissociates upon dissolution in water into protons and anions.

3. The regeneration method (100) according to claim 2,
wherein the base gas is electrochemically converted to an anionic species in the dissolved state and when a voltage is applied.

4. The regeneration method (100) according to claim 1,
wherein
the reconditioning reagent comprises at least one acid in an aqueous phase.

5. The regeneration method (100) according to claim 1,
wherein
the reconditioning reagent comprises at least one chelating agent in an aqueous phase.

6. The regeneration method (100) according to claim 4,
wherein
the at least one acid and/or the at least one chelating agent are present as dissolved protons and anions or in molecular form.

7. The regeneration method (100) according to claim 1,
wherein
the reconditioning reagent comprises a solution comprising a substance, that is capable of being converted into a neutral or anionic substance by applying an electrical voltage.

8. The regeneration method (100) according to claim 1,
wherein
water produced in the fuel cell stack (201) is used to rinse (103) the reconditioning reagent and the impurities.

9. The regeneration method (100) according to claim 1,
wherein
when flushing (103) under wet-cold operating conditions, a cell voltage is set that is below a predetermined regeneration value.

10. The regeneration method (100) according to claim 1,
wherein
upon or after introduction of the reconditioning reagent, a voltage applied in the fuel cell stack (201) is increased above a predetermined conditioning value to initiate a reaction of the reconditioning reagent with impurities present in the fuel cell stack (201).

11. A fuel cell system (200) for converting energy,
wherein the fuel cell system (200) comprises the following:
a fuel cell stack (201),
a dosing system (203) for metering reconditioning reagent into the fuel cell stack (201), and
a computer,
wherein the computer is configured to activate the dosing system (203) and the fuel cell stack (201) to control introduction of a reconditioning reagent into the fuel cell stack (201), and flushing (103) the reconditioning reagent from the fuel cell stack (201), wherein the reconditioning reagent contains mobile anions or a precursor of mobile anions.

12. A fuel cell system (200) for converting energy,
wherein the fuel cell system (200) comprises the following:
a fuel cell stack (201),
an interface (207) for connecting to a dosing system (03) for metering reconditioning reagent into the fuel cell stack (201).
